(19) United States
(12) Patent Application Publication
(10) Pub. No.: US 2020/0106083 A1
(43) Pub. Date: Apr. 2, 2020

(54) PROCESS FOR PREPARING A GELLED ELECTROLYTE

(71) Applicant: COMMISSARIAT A L'ENERGIE ATOMIQUE ET AUX ENERGIES ALTERNATIVES, PARIS (FR)

(72) Inventors: Camille Guerin, Grenoble (FR); Gérard Gebel, Grenoble (FR); Lionel Picard, Grenoble (FR)

(21) Appl. No.: 16/586,792

(22) Filed: Sep. 27, 2019

(30) Foreign Application Priority Data
Sep. 28, 2018 (FR) 1858964

(51) Int. Cl. H01M 4/04; H01M 10/0525; H01M 4/525; H01M 4/60

(52) U.S. Cl. CPC H01M 4/0452; H01M 10/0525; H01M 2004/023; H01M 4/602; H01M 4/0466; H01M 4/525

(57) ABSTRACT

The invention relates to a process for functionalizing the electrically conductive or semi-conductive surface of an electrode by electro-grafting of a polymeric film obtained from an ionic liquid monomer, the cation of which bears at least one electro-polymerizable function.

The invention is also directed toward a process for preparing a gelled electrolytic membrane at the surface of an electrode, by gelling the electro-grafted polymeric film, and also to the use of the electrode/electrolytic membrane assembly thus obtained in a lithium battery.

### CROSS REFERENCE TO RELATED APPLICATION

This application claims priority of French Patent Application No. 1858964, filed Sep. 28, 2018, the contents of which are hereby incorporated by reference herein their entirety.

The present invention relates to a novel process for preparing a gelled electrolyte, directly on the surface of an electrode intended to be used in an electrochemical storage system, and also to an electrode/gelled electrolytic membrane assembly thus obtained.

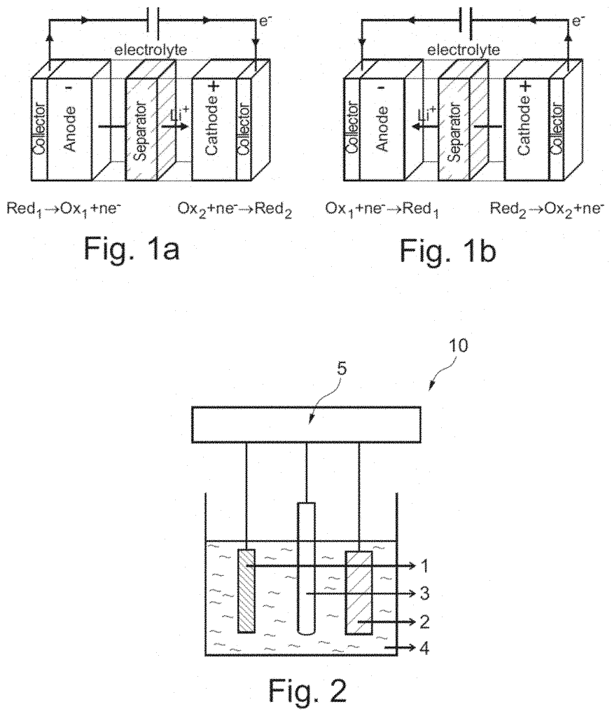

In general, as represented schematically in FIGS. 1a and 1b, a lithium battery comprises the following elements:
a positive-electrode current collector, generally made of aluminum;
a positive electrode, comprising a material for inserting/deinserting lithium cations. It is generally a porous composite comprising said ion inserting/deinserting active material and electron-conducting additives in a porous polymer matrix;
an electrolytic constituent. It is more particularly a porous polymeric film, the separator, soaked with an organic electrolyte;
a negative electrode. It may be a porous composite in lithium-ion technology or a lithium film in the case of lithium-metal technology; and
a negative-electrode current collector, generally made of copper.

The lithium-cation insertion material of the positive electrode is generally a composite material, for example lithium iron phosphate, LiFePO₄, or a transition metal oxide, for example a lithium cobalt oxide (LiCoO₂), lithium nickel oxide (LiNiO₂), etc.

The presence of the electrolyte makes it possible to ensure the transport of the lithium ions between the electrodes during the charging and discharging of the battery. It is generally a mixture of organic solvents, generally of alkyl carbonate type, in which is dissolved a lithium salt, typically LiPF₆. Unfortunately, the melting and boiling points of the solvents, and also the reactivity of the salt LiPF₆, limit the range of temperatures in which the battery is operational. Furthermore, the liquid electrolyte solvents are generally flammable. During thermal runaway reactions, there is a risk of leakages, which may lead to fires, or even explosions.

To overcome these drawbacks, solid electrolyte technology was developed. The liquid electrolyte may be replaced with a solid polymer, which has ion conduction and electrical insulation properties. It thus acts both as an electrolyte and as a separator. The one most commonly known and most widely used at the present time is poly(ethylene oxide) (PEO), in which is dissolved a lithium salt, developed and patented by Armand et al. in 1978. Its use advantageously makes it possible to improve the operating temperatures and safety of batteries.

However, one of the major limitations of polymeric electrolytes remains their low ion conductivities at ambient temperature. To overcome this problem, gelled polymeric electrolytes have already been proposed. These electrolytes in the form of a gel (by definition a liquid trapped in a solid matrix), thus comprise the electrolyte (liquid aprotic solvent containing the lithium salt) within a polymer matrix. The risks of leakages are reduced due to their solid behavior. Migration takes place in the liquid phase of the gel, making it possible to achieve ion conductivities at ambient temperature close to those of conventional liquid electrolytes.

Two routes for synthesizing polymeric electrolytes in the form of a film are typically used. The first is extrusion, which is a technique that is well known in plastics engineering. The second works by dissolving the polymer in a solvent, coating on a flat surface, and then drying. Once the polymeric electrolyte films have been formed, they are laminated on the surface of the electrode during the assembly of the electrochemical cells. The thicknesses of the polymeric electrolyte films deposited are of the order of a micrometer.

Despite everything, the solvents used generally remain carbonates, which are flammable, toxic products. Alternative compounds to these solvents have thus been proposed, making it possible to form a gel with the polymer matrix, in particular plastic crystal compounds, such as dinitrile compounds as described in patent application WO 2017/032940. Within a regular crystalline network, these compounds have dynamically disordered motion. The mobility of molecules is greater in disordered systems, which allows faster transport of the Li⁺ ions and thus better ion conductivity even at ambient temperature.

The present invention proposes a novel route for synthesizing a gelled polymeric electrolyte, by directly preparing the electrolyte on the surface of the electrode intended for a lithium battery, and advantageously making it possible to dispense with the use of solvent.

More precisely, the present invention proposes to afford access to an electrode/gelled electrolytic membrane assembly via the preparation, directly on the surface of an electrode intended for a lithium battery, of an electro-grafted polymeric film, obtained from an ionic liquid monomer, the cation of which bears at least one electro-polymerizable function.

Thus, according to a first of its aspects, the invention relates to a process for functionalizing the electrically conductive or semi-conductive surface of an electrode, in particular of an electrode intended for a lithium battery, notably a lithium-based electrode, by electro-grafting of a polymeric film obtained from an ionic liquid monomer, the cation of which bears at least one electro-polymerizable function.

The invention also relates to a structure, as obtained on conclusion of the process as defined previously, comprising an electrode having an electrically conductive or semi-conductive surface, onto which is covalently grafted a polymeric film, obtained by electro-polymerization from an ionic liquid monomer, the cation of which bears at least one electro-polymerizable function.

Electro-polymerization is a known technique for producing thin organic films on electrically conductive or semi-conductive surfaces. Among the electro-polymerization techniques, electro-grafting makes it possible to afford access to polymeric films that have been covalently grafted onto the surface of interest. In general, electro-grafting is based on the generation of radicals in solution (initiation), by electron exchange between the substrate and an electro-active monomer dissolved in an electrolyte, and the polymerization, by chain propagation, of the electro-active monomers on the surface of interest, acting both as the electrode in the electrolysis cell and as the polymerization initiator.

Electro-grafting requires the use of precursors suited to its mechanism of initiation by reduction and of propagation, generally anionic. Cathodically initiated electro-grafting is preferred, since it is applicable to noble and non-noble metals (in contrast with electro-grafting by anionic polymerization, which is applicable only to noble substrates). “Depleted vinyl” molecules, i.e. molecules bearing electron-withdrawing functional groups, such as acrylonitriles, acrylates, vinylpyridines, etc., are particularly suited to this process, which gives rise to numerous applications in the microelectronics or biomedical sector.

The invention thus exploits the electro-grafting technique to afford access to an electro-grafted electrically insulating film on the surface of an electrode which is useful in a lithium battery, in particular of a lithium-based electrode.

Advantageously, electro-grafting makes it possible to afford access to a film of low thickness, which is uniform and which is covering on any electrically conductive and semi-conductive surface, and of controlled thickness.

Such an electro-grafted film may be advantageously converted into a gelled electrolyte via the addition of a suitable gelling solvent and of a lithium salt.

Thus, according to another of its aspects, the invention also relates to a process for preparing a gelled electrolytic membrane on the surface of an electrode, preferably of a lithium-based electrode, comprising at least the following steps:

(a) providing an electrode, preferably a lithium-based electrode, on which is covalently grafted an electrically insulating polymeric film, obtained by electro-polymerization from an ionic liquid monomer, the cation of which bears at least one electro-polymerizable function; and

(b) gelling the polymeric film by adding a solution of lithium salt in a dinitrile compound of formula N≡C—R—C≡N, in which R is a CₙH₂ₙ hydrocarbon-based group, n being an integer between 1 and 6, or in one or more solvents such as carbonates.

The invention also relates to an electrode/electrolytic membrane assembly, as obtained according to the process described previously, comprising an electrode, preferably a lithium-based electrode, supporting a gelled electrolytic membrane, obtained according to the process defined previously.

The preparation, according to the process of the invention, of a gelled electrolytic membrane directly on the surface of an electrode, in particular of a lithium-based electrode intended for a lithium battery, from a polymeric film electro-grafted to the surface of the electrode, proves to be advantageous in several respects.

Firstly, advantageously, the synthesis of the polymeric electrolyte membrane directly on the surface of the electrode is performed using an electro-grafted polymeric film, in other words involving the establishment of a covalent bond between the polymer and the surface of the electrode. It thus ensures an intimate interface between the electrode and the electrolyte membrane formed, and strong adhesion of the gelled electrolytic membrane to the electrode. Consequently, the contact resistances between the two electrode/electrolytic membrane components are advantageously minimized.

Also, electro-grafting makes it possible to adjust, in particular to minimize, the thickness of the polymeric film formed and, consequently, the thickness of the gelled electrolytic membrane obtained.

As detailed in the continuation of the text, the electro-grafting may thus be performed by polarization under cyclic voltammetry conditions, by adjusting the operating conditions, notably in terms of the value of the maximum imposed potential, the sweep rate, the number of sweep cycles and/or the temperature of the electrolysis medium, to control the properties of the polymeric film formed, in particular its thickness.

In particular, the thickness of the gelled electrolytic membrane obtained according to the invention may be less than or equal to 500 nm, in particular between 50 nm and 300 nm and more particularly between 100 nm and 150 nm. A low thickness of the electrolyte in a battery advantageously makes it possible to reduce the ion diffusion pathways during the functioning of the battery, and thus to conserve a low migration resistance.

Moreover, the electro-grafting technique makes it possible to give a continuous and uniform film, in particular of homogeneous thickness, and to do so irrespective of the form of the electrode and more particularly irrespective of its surface topography. Thus, the process of the invention may be performed on the surface of a flat electrode, but also for 3D electrodes of foam type.

Electro-grafting also provides a covering deposit of the electrically insulating polymeric film, thus making it possible to avoid any risk of short-circuiting in the battery formed on conclusion of the gelling of the electro-grafted film.

The gelled electrolytic membrane prepared according to the invention thus simultaneously has excellent ion conductivity and electrical insulating properties. It ensures both its electrolytic function in a lithium battery, and a separating function between the electrode, generally the cathode, on which it is formed, and the opposite electrode, typically the anode.

What is more, the preparation of the gelled electrolytic membrane on the surface of the electrode according to the invention dispenses with the use of flammable and toxic solvents.

In point of fact, as detailed in the continuation of the text, the electro-grafting and gelling are performed without adding solvent, the electro-grafting being performed in an electrolytic solution in which said ionic liquid acts both as monomer and as solvent. The gelling of the electro-grafted film is, for its part, performed using a plastic crystal compound, of dinitrile type, and does not require the addition of an auxiliary solvent.

According to another of its aspects, the invention also relates to the use of an electrode/electrolytic membrane assembly prepared according to the invention in a lithium battery, in particular in a lithium-ion battery.

The invention also relates to a lithium battery, in particular a lithium-ion battery, comprising an electrode/electrolytic membrane assembly according to the invention.

Other characteristics, variants and advantages of the invention will emerge more clearly on reading the detailed description and the examples, which are given with reference to the attached drawings in which:

FIGS. 1a and 1b represent, schematically and partially, the operating principle of a conventional lithium battery, during discharging (a) and charging (b);

FIG. 2 represents, schematically and partially, the electrochemical assembly with three electrodes, for performing the electro-polymerization using the electrolytic solution comprising the (ionic liquid) monomer to be polymerized.

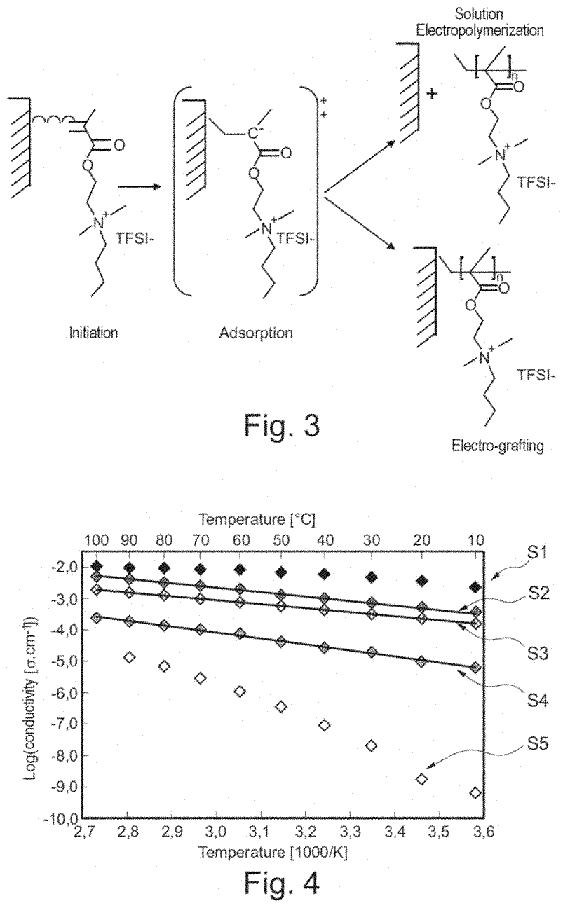

FIG. 3 represents, schematically, the various mechanisms for the electro-polymerization of N,N,N,N-n-butyldimethylmethacryloyloxyethylammonium bis(trifluoromethanesulfonyl)imide (BDMA).

FIG. 4 is a graph illustrating the change in ion conductivity (log of the conductivity in mS·cm⁻¹) as a function of the temperature (1000/K for the lower x-axis and ° C. for the upper x-axis) for the various electrolytes prepared according to example 1;

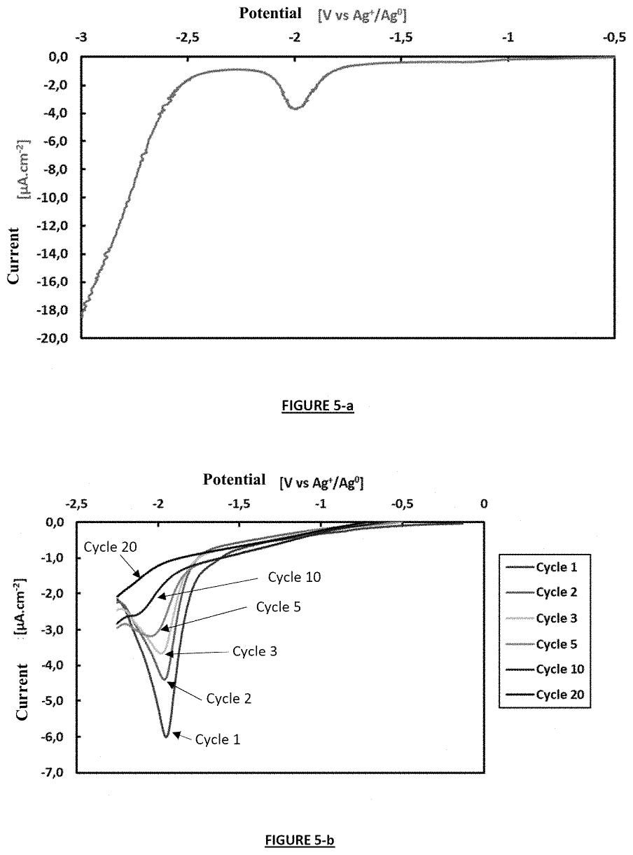

FIGS. 5a and 5b represent the voltammograms obtained with the electro-polymerization assembly according to example 2, for the first potential sweep cycle between the OCV (“Open Circuit Voltage” or no-load current) and −3V vs Ag⁺/Ag⁰, at a sweep rate of 0.1 mV·s⁻¹ (FIG. 5-a) and during the first 20 potential sweep cycles between the OCV and −2.25V vs Ag⁺/Ag⁰, at a sweep rate of 1 mV·s⁻¹ (FIG. 5-b);

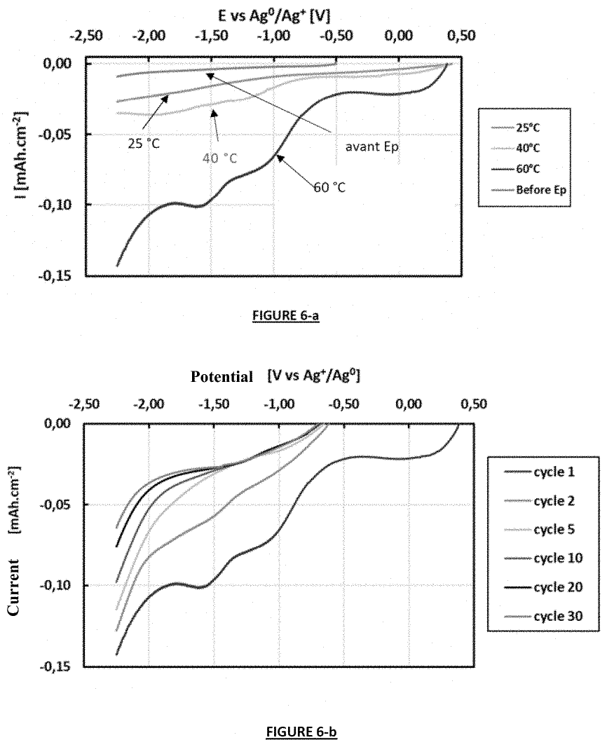

FIGS. 6a and 6b represent the voltammograms obtained with the electro-polymerization assembly according to example 3, for a first potential sweep cycle between the OCV and −2.25V vs Ag⁺/Ag⁰, at a sweep rate of 1 mV·s⁻¹, at various temperatures of the electrolytic solution; and during the first 30 sweep cycles at a temperature of 60° C.

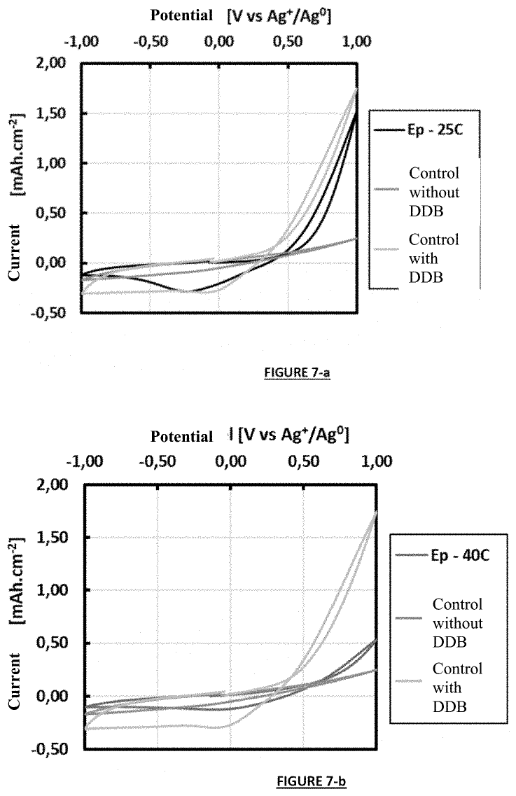

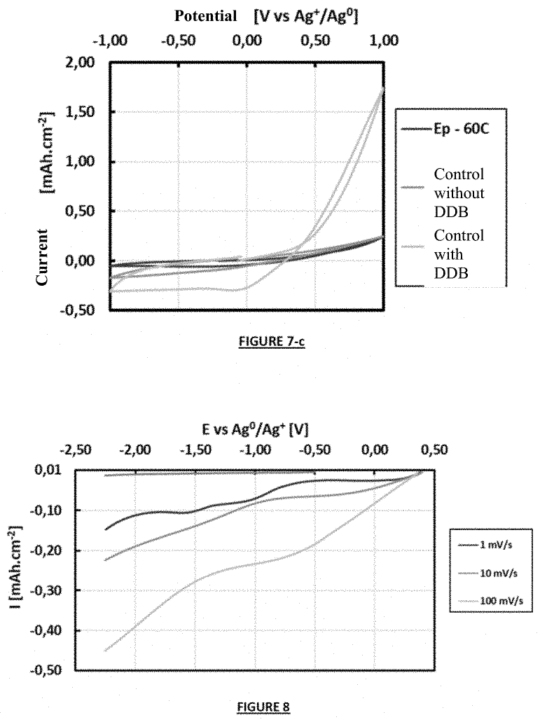

FIGS. 7a, 7b, and 7c represent the various voltammograms obtained with the electrochemical assembly according to example 4, with various working electrodes: a naked Ni/LiNiO₂ electrode in an electrolytic solution not containing a RedOx probe, a naked Ni/LiNiO₂ electrode after addition of the RedOx probe and an Ni/LiNiO₂ electrode on which the electro-grafting was performed under the conditions of example 3, at 25° C. (FIG. 7-a), 40° C. (FIG. 7-b) and 60° C. (FIG. 7-c).

FIG. 8 represents the voltammograms obtained with the electro-polymerization assembly according to example 5, for a first potential sweep cycle between the OCV and −2.25V vs Ag⁺/Ag⁰, at 60° C. and for various sweep rates of 1 mV·s⁻¹, 10 mV·s⁻¹ and 100 mV·s⁻¹.

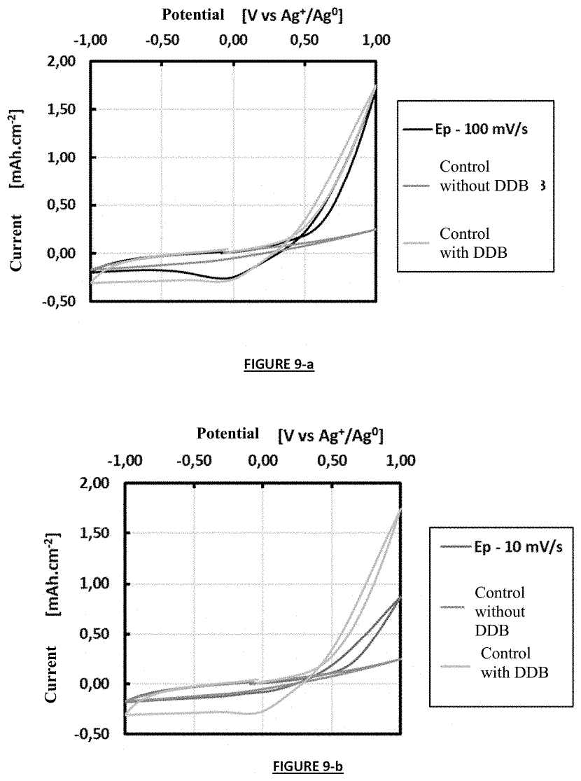

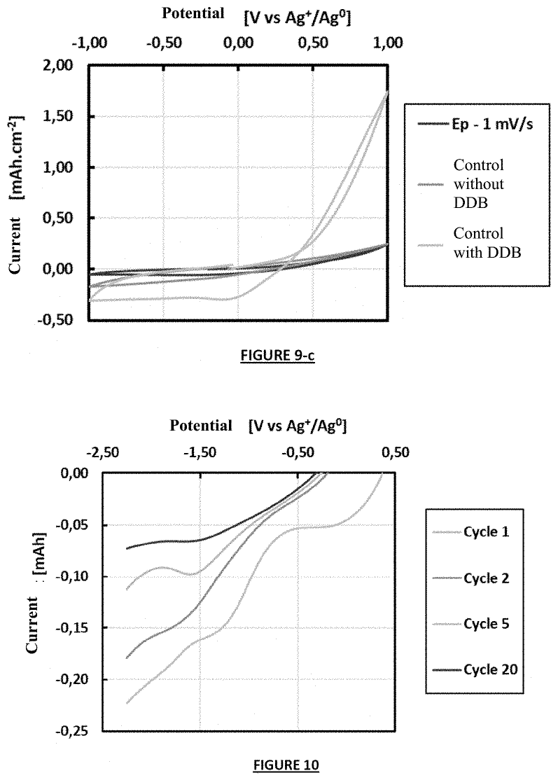

FIGS. 9a, 9b, and 9c represent the various voltammograms obtained with the electrochemical assembly according to example 5, with various working electrodes: a naked Ni/LiNiO₂ electrode in an electrolytic solution not containing a RedOx probe, a naked Ni/LiNiO₂ electrode after addition of the RedOx probe and an Ni/LiNiO₂ electrode on which the electro-grafting was performed under the conditions of example 5, at 100 mV/s (FIG. 9-a), 10 mV/s (FIG. 9-b) and 1 mV/s (FIG. 9-c);

FIG. 10 represents the voltammogram obtained with the electro-polymerization assembly according to example 6, on the surface of a nickel/LiNiO₂ foam, performed with a potential sweep between the OCV and −2.25V vs Ag⁺/Ag⁰, at a sweep rate of 1 mV·s⁻¹, at 40° C.

In the continuation of the text, the expressions “between . . . and . . . ”, “ranging from . . . to . . . ” and “varying from . . . to . . . ” are equivalent and are intended to mean that the limits are included, unless otherwise mentioned.

Unless otherwise indicated, the expression “including a(n)” should be understood as “comprising at least one”.

Electro-Grafting on the Surface of an Electrode

As indicated previously, the preparation of an electrolytic membrane according to the invention, directly on the surface of an electrode, proceeds, in a first stage, via the formation by electro-grafting, on the surface of an electrode, of a polymeric film, using an ionic liquid monomer bearing at least one electro-polymerizable function.

Support Electrode

The electro-grafting may be performed on any type of conductive or semi-conductive surface, for any possible surface geometry.

Thus, the process may be performed on any electrode, irrespective of its form and in particular irrespective of its surface topography. It may thus be a flat electrode, but also a 3D electrode, like a foam.

As indicated previously, the electrode on the surface of which the electro-grafted polymeric film is formed is more particularly an electrode intended for use in a lithium battery, in particular in a lithium-ion battery.

It is preferably an electrode intended to form the cathode in a lithium battery.

Typically, an electrode comprises, or even is formed from, an electrode active material, in particular a lithium-based material, where appropriate supported on a conductive substrate, for example a metal substrate.

It is understood that the electrode material must be chemically and electrochemically stable under the electrolysis synthetic conditions used for the electro-grafting of the polymeric film.

Also, preferably, the electrode material is chosen so as to have good affinity with the monomer of ionic liquid type used as monomer and solvent for the electrolytic solution for the electro-polymerization, so as to promote the adsorption of the monomer to its surface.

The affinity of the ionic liquid monomer with the electrode material may notably be assessed by the wettability of the ionic liquid with respect to the electrode material, good wettability of a liquid medium with respect to a given material meaning a contact angle of a drop of said liquid medium deposited on a support made of said material, of less than 90°. The determination of the contact angle may be performed, in a manner known to a person skilled in the art, using a goniometer.

According to a particularly preferred embodiment, the electrode is a lithium-based electrode, comprising a material chosen from lithium transition metal oxides and other lithium transition metal compounds, such as lithium transition metal phosphates, and mixtures thereof.

As examples of lithium transition metal oxides, mention may be made of lamellar oxides Li(Co, Ni, Mn, Al)O₂ and oxides of spinel structure of the type Li₁₊ₓMn₂O₄ with 0≤x≤0.1.

Preferably, it may be a lithium nickel oxide (LiNiO₂).

The electrode material may also be chosen from the compounds having the following general formula LiₓM_{y}(XO_{z})ₙ, in which:

M represents an element chosen from Mn, Fe, Co, Ni, Cu, Mg, Zn, V, Ti, Al, Si, B, Cr, Mo and mixtures thereof;

X represents an element chosen from P, Si, Ge, S, V and As;

x, y, z and n are positive integers or decimal numbers chosen such that the total charge of the cations compensates for the total charge of the anions, so that the compound is electrically neutral.

Preferably, M represents an element chosen from Mn, Fe, Co, Ni, Cu, V, Ti, B, Cr, Mo and mixtures thereof.

More precisely, such compounds may correspond to the case where X corresponds to the element phosphorus P, in which case these compounds constitute lithium phosphate compounds. Such compounds may be, for example, LiFePO₄ or Li₃V₂(PO₄)₃.

The electrode used according to the invention may more particularly have on the surface film of lithium-based inorganic material, as described previously, in particular a film of lithium transition metal oxide, for instance a film of lithium nickel oxide (LiNiO₂).

The film of lithium-based inorganic material may notably have a thickness of between 10 μm and 300 μm, in particular between 50 μm and 150 μm.

In one particular embodiment, the electrode is constituted of a flat support of pure metal or metal oxide, or a foam of pure metal or of metal oxide, having on the surface a film of lithium transition metal oxide.

For example, the electrode may be constituted of a flat nickel support or of a nickel foam, having on the surface a film of lithium nickel oxide (LiNiO₂).

The active material, in particular the lithium transition metal oxide, may represent from 50% to 95%, in particular from 70% to 90%, relative to the total mass of the electrode.

Besides the active material, the electrode may advantageously comprise at least one electron conductor. This may notably be carbon black and/or carbon fibers. It may represent from 1% to 10%, in particular from 3% to 5%, of the mass of the electrode.

The electrode, in particular the lithium-based electrode, on the surface of which is performed the electro-grafting of the polymer according to the invention, may be prepared beforehand via any technique known to those skilled in the art.

It may be manufactured, for example, by depositing an electrode ink comprising the electrode active material onto the surface of a substrate. The deposition may be performed via any conventional technique, for example by coating, printing (screen printing, inkjet printing, etc.) or by spraying.

Ionic Liquid Monomer Bearing at Least One Electro-Polymerizable Function

The electro-grafted polymeric film is prepared from a monomer of ionic liquid type, the cation of which bears at least one electro-polymerizable function.

The term “ionic liquid” means a salt that is in liquid form, an ionic liquid being able to be represented by the general formula (I) below:

A⁺X⁻ (I),

in which:

A⁺ represents a cation, generally an organic cation; and

X⁻ represents an anion.

The cation of an ionic liquid according to the invention is more particularly an organic cation bearing at least one polymerizable function, and more particularly an electro-polymerizable function.

Such ionic liquids have been described, for example, in patent application WO 2015/0441136. However, these ionic liquids are, firstly, not at all proposed as precursors for the formation of an electro-grafted film. Secondly, the ionic polymers, derived from the polymerization of these ionic liquids, are only used in said document to dissolve and/or dissociate the lithium salt, and thus not in any way to form by themselves, in a gelled form, an electrolytic membrane. More particularly, the ionic polymers proposed in said document are used, in a composition intended to form an electrolytic membrane, in combination with a lithium salt and a nonionic polymer, such as a polyolefin, intended to ensure the mechanical strength of the composition.

An “electro-polymerizable” function denotes a polymerizable and electro-active function.

A “polymerizable function” is a function that is capable of polymerizing to form a polymer resulting from a sequence of repeating units derived from the polymerization of said polymerizable group.

The term “electro-active” function denotes a function that is capable of being oxidized or reduced, preferably reduced, by means of an electric current.

Preferably, the electro-active function is a function that is capable of being reduced. The electro-reduced monomer is the initiator of radical polymerization reactions.

Thus, preferably, as detailed in the continuation of the text, the electro-grafting is performed under cathodic polarization, the growth of the grafted chains then taking place by anionic or radical polymerization.

An electro-polymerizable function may more particularly contain an unsaturation. As examples of electro-polymerizable functions, mention may be made of pyrrole, acetylene, thiophene, azine, p-phenylene, p-phenylene vinylene, pyrene, furan, selenophene, pyridazine, carbazole, aniline, indole, acrylate, methacrylates and derivatives thereof.

Preferably, the electro-polymerizable function is an activated vinyl function, in particular a methacrylate function.

As detailed in the continuation of the text, the presence of an electro-polymerizable function is essential to allow grafting by covalent bonding on the surface of the electrode and, moreover, to initiate the growth of the polymer chains.

The cation of the ionic liquid, bearing an electro-polymerizable function, in particular an activated vinyl function, may be symbolized by the general formula:

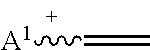

a single unsaturated function being represented here by the double bond ═. The wavy bond represents a covalent bond connecting a carbon atom of the double bond to the group Al. It is not excluded for other groups to be connected to the carbon atoms of the double bond, the simplification favored consisting here in representing only the group Al.

The cation may be a compound including at least one nitrogen atom, at least one phosphorus atom or at least one sulfur atom, the positive charge of which is borne by said nitrogen atom, said phosphorus atom or said sulfur atom; this nitrogen, phosphorus or sulfur atom possibly forming part of a linear or branched hydrocarbon-based chain or a hydrocarbon-based ring.

In particular, the cation may be a compound including at least one nitrogen atom, the positive charge of which is borne by said nitrogen atom, this nitrogen atom possibly forming part of a linear or branched hydrocarbon-based chain or a hydrocarbon-based ring.

When the positively charged nitrogen atom forms part of a linear or branched hydrocarbon-based chain, the cation may be an aliphatic ammonium cation, and may more specifically correspond to the general formula (II) below:

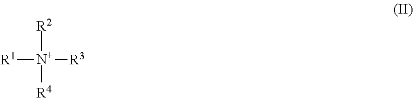

in which R¹, R², R³ and R⁴ represent, independently of each other, a hydrocarbon-based group, with at least one of the groups R¹, R², R³ and R⁴ being a hydrocarbon-based group bearing at least one electro-polymerizable function, such as that mentioned above.

When it is not a hydrocarbon-based group bearing at least one electro-polymerizable function, the abovementioned hydrocarbon-based group may be an optionally fluorinated alkyl group comprising from 1 to 12 carbon atoms.

Examples of such cations may be those of general formulae (III) and (IV) below:

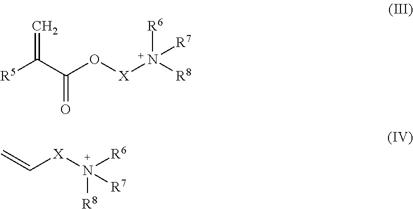

in which:
R⁶, R⁷ and R⁸ represent, independently of each other, an optionally fluorinated alkyl group comprising from 1 to 12 carbon atoms;
X represents an optionally fluorinated alkylene group comprising from 1 to 6 carbon atoms; and
R⁵ represents a hydrogen atom or a methyl group.

Specific examples falling within the context of these formulae may be the specific compounds of formulae (V) and (VI) below:

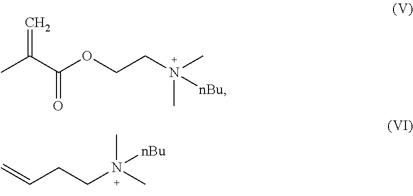

the first compound being N,N,N,N-n-butyldimethylmethacryloyloxyethylammonium, nBu corresponding to the n-butyl group.

When the charged nitrogen atom forms part of a hydrocarbon-based ring, the cation may correspond to one of the formulae (VII) and (VIII) below:

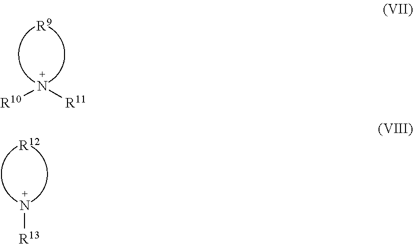

in which:
N⁺ and R⁹ together form an alicyclic group;
N⁺ and R¹² together form an aromatic group;
R¹⁰, R¹¹ and R¹³ represent, independently of each other, a hydrocarbon-based group, with at least one of the groups R¹⁰, R¹¹ and R¹³ being a hydrocarbon-based group bearing at least one polymerizable function, such as that mentioned above.

Examples of cations of formula (VII) may be piperidinium cations or pyrrolidinium cations.

Specific examples of cations of formula (VIII) may be imidazolium cations or pyridinium cations.

Even more specifically, examples of cations may be those corresponding to formulae (IX) and (X) below:

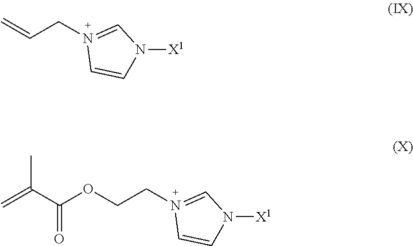

in which X¹ represents an optionally fluorinated alkyl group of 1 to 6 carbon atoms.

As regards the anion of the ionic liquid, it may be a compound comprising a heteroatom bearing a negative charge, this heteroatom possibly being chosen from a nitrogen atom, a boron atom, a phosphorus atom or a chlorine atom.

More specifically, it may be:
an imide compound, which is in particular perfluorinated, such as a bis(trifluoromethylsulfonyl)imide compound (which may also be named bis(trifluoromethanesulfonyl)imide) of formula (XI) below:

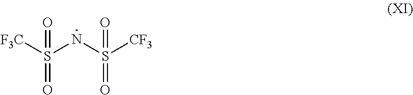 [SMILES: O=S(=O)(NS(=O)(=O)C(F)(F)F)C(F)(F)F]

a perfluorinated borate compound, such as a tetrafluoroborate compound of formula (XII) below:

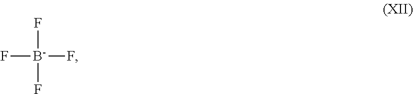

a phosphate compound, such as a compound of formula PF₆_{^{−}}; or
a chloro compound, such as a chlorate compound of formula ClO₄_{^{−}}.

A specific ionic liquid may be an ionic liquid resulting from the combination:
of an aliphatic ammonium cation corresponding to the general formula (II) below:

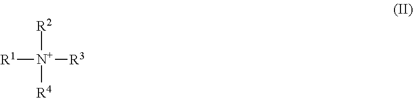

in which R¹, R², R³ and R⁴ represent, independently of each other, a hydrocarbon-based group, with at least one of the groups R¹, R², R³ and R⁴ being a hydrocarbon-based group bearing at least one polymerizable function, such as that mentioned above; and
an imide anion, which is preferably perfluorinated.

A particular example of an ionic liquid falling within this category is an ionic liquid resulting from the combination:
of a cation of formula (V) below:

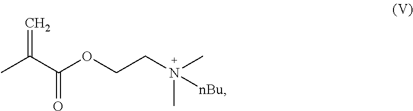

and
of an anion of formula (XI) below:

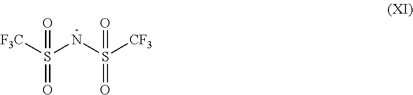 [SMILES: O=S(=O)(NS(=O)(=O)C(F)(F)F)C(F)(F)F]

in other words N,N,N,N-n-butyldimethylmethacryloyloxyethylammonium bis(trifluoromethanesulfonyl)imide.

Thus, the ionic polymer derived from the polymerization of such an ionic liquid may consist of a sequence of a repeating unit of formula (XIII) below:

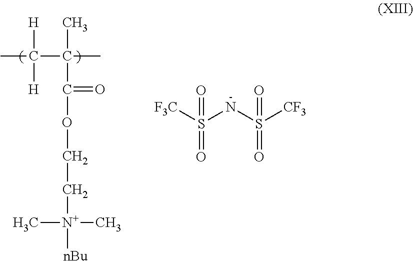

More generally, the ionic polymer derived from the polymerization of an ionic liquid, having the following simplified general formula:

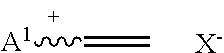

may be represented by the following simplified general formula:

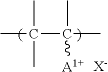

The monomer of ionic liquid type may optionally be combined with one or more comonomers, notably for the purpose of improving the ion conductivity, facilitating the implementation of the polymerization or the mechanical properties of the gel.

Examples of comonomers may be vinyl comonomers, such as methacrylate comonomers and styrene comonomers. Preferably, the polymerizable functions of the monomer are of the same nature as those of the cation of the ionic liquid. In other words, when the cation of the ionic liquid includes, for example, (meth)acrylate functions, the polymerizable functions of the comonomer are also, preferably, (meth)acrylate functions.

Formation of a Polymeric Film by Electro-Grafting

The electro-grafting of the polymeric film starting with the ionic liquid monomer may more particularly be performed starting with a conventional electrochemical assembly, using the electrode on the surface of which it is desired to form the polymeric film as working electrode, and at least one counterelectrode.

More particularly, as represented schematically in FIG. 2, it may be performed using an electrochemical assembly (10) with three electrodes, comprising:
the electrode to be functionalized (1), known as the “working electrode”, which is preferably lithium-based, which may act as anode or cathode depending on the applied voltage;
a reference electrode (3), the potential of which is known and constant, allowing the measurement of a potential difference, for example a silver electrode; and
an auxiliary electrode (2), also known as the “counterelectrode”, made of inert metal, for example of platinum, which makes it possible to measure the current circulating in the electrochemical cell.

The electrolytic solution (4) typically contains the electro-active monomer.

The kinetics of the electro-grafting according to the invention may notably be monitored by means of a potentiostat (5).

Advantageously, the electrolytic solution used for the electro-grafting according to the invention may be formed from said ionic liquid, without the need to use an auxiliary solvent. In point of fact, the ionic liquid serves both as monomer and as solvent for the electro-grafting.

The electrolytic solution formed from said ionic liquid is preferably supplemented with a support electrolyte, to facilitate the passage of the electric current through the electrolytic solution.

The support electrolyte may be chosen from lithium salts, quaternary ammonium salts, such as quaternary ammonium perchlorates, tosylates, tetrafluoroborates, hexafluorophosphates or halides, sodium nitrate and sodium chloride.

Preferably, the support electrolyte salt is chosen of the same nature as the electrolyte salt used in the gelled electrolytic membrane formed from the electro-grafted polymer, as detailed in the continuation of the text. It is thus preferably a lithium salt, as described in the continuation of the text, for instance lithium bis(trifluoromethanesulfonyl)imide (LiTFSI).

Thus, the process for functionalizing an electrode according to the invention more particularly comprises the steps consisting in:

(i) preparing an electrolytic solution comprising, or even being formed from, an ionic liquid, where appropriate supplemented with a support electrolyte, in particular a lithium salt; and

(ii) electrolyzing said solution in an electrolysis cell using said electrode on which the polymeric film is to be formed, as working electrode, and at least one counterelectrode, under conditions suitable for the formation of a polymeric film covalently grafted onto the surface of the electrode.

The electro-grafting is more particularly performed by cathodic polarization of the surface of the electrode to be functionalized. This polarization is measured relative to the reference electrode, for example a silver electrode.

More particularly, the production of the grafted polymer film by electro-grafting of the ionic liquid, in particular bearing an activated vinyl function, on the conductive surface of the electrode, takes place by means of an electro-initiation of the polymerization reaction starting from the surface, followed by growth of the chains monomer by monomer.

The reaction mechanism of cathodic polarization electro-grafting is represented, for example, in FIG. 3 for the ionic liquid monomer N,N,N,N-n-butyldimethylmehacryloyloxyethylammonium bis(trifluoromethanesulfonyl)imide, abbreviated as BDMA in the continuation of the text. The anionic radicals adsorbed onto the surface of the electrode will serve as initiators for the polymerization reaction; the growth of the grafted chains takes place by anionic polymerization. The reaction mechanisms involved during the electro-grafting are described, for example, in FR 2 843 757.

The electro-polymerization of the electrolytic solution based on the ionic liquid may be performed by polarization under linear or cyclic voltammetry conditions, under potentiostatic, potentiodynamic, intensiostatic, galvanostatic or galvanodynamic conditions or by simple or pulsed chronoamperometry.

Advantageously, it is performed by polarization under cyclic voltammetry conditions.

It falls to a person skilled in the art to adjust the implementation conditions of the electro-polymerization so as to lead to the production of a desired electro-grafted film.

In point of fact, as represented in FIG. 3, depending on the electro-polymerization parameters, two mechanisms may be favored, on the one hand solution electro-polymerization taking place in the region of the working electrode and, on the other hand, electro-grafting. Unlike solution electro-polymerization, electro-grafting leads to the attachment of the synthesized polymer to the surface of the electrode via the establishment of a covalent bond.

More particularly, as illustrated in the examples that follow, it falls to a person skilled in the art to adapt the voltammetry conditions, in particular the value of the sweep stop potential, to obtain a chemical film grafted onto the surface of the working electrode. In general, electro-grafting takes place at a potential, as an absolute value, below that at which solution electro-polymerization takes place.

Thus, electro-grafting is performed according to the invention with a potential sweep not exceeding, as an absolute value, a limit value, at which solution electro-polymerization takes place. This maximum potential value may be identified empirically by a person skilled in the art, as illustrated in the examples that follow.

The electro-grafting according to the invention may notably be monitored by means of a voltammogram as represented in FIGS. 5a and 5b.

Similarly, the properties of the electro-grafted film obtained, in particular its thickness, may be controlled by adjusting the operating conditions.

It is important, notably in view of its use for forming the electrolytic membrane in a battery, for the electro-grafted polymeric film to be thick enough to ensure good electrical insulation. On the other hand, it is desirable to obtain a film of low thickness, so as to optimize the ion conductivity of the electrolytic membrane prepared from this film.

Advantageously, the electro-grafted polymeric film has a thickness of greater than or equal to 10 nm, and advantageously less than or equal to 300 nm, preferably between 50 and 100 nm.

The thickness of the film formed by electro-grafting on the surface of the electrode may be more particularly controlled via adjustment of the experimental parameters, which are empirically accessible to a person skilled in the art, as illustrated in the examples that follow.

In particular, the thickness of the film is dependent on the number of sweep cycles in the case of cyclic voltammetry. The number of cycles may be between 5 and 50, in particular between 10 and 30.

The thickness of the electro-grafted film may also be controlled by the polarization time, the latter being able to be adjusted by means of the voltammetry sweep rate.

Also, the electro-polymerization reaction may advantageously be activated by heating. Thus, the electrolytic solution may be brought to a temperature of greater than or equal to 0° C., in particular between 40 and 60° C.

For example, as illustrated in the examples, the electro-grafting using the ionic liquid N,N,N,N-n-butyldimethylmethacryloyloxyethylammonium bis(trifluoromethanesulfonyl)imide, may be performed by performing a linear sweep between the OCV (“Open Circuit Voltage” or no-load current) and −2.25V vs Ag⁺/Ag⁰, at a sweep rate of 1 mV·s⁻¹, at a temperature of between 20 and 60° C. and for a number of sweep cycles of between 10 and 30.

The electro-grafting performed using an ionic liquid monomer according to the invention leads to the formation of a polymeric film grafted with carbon-metal covalent bonds on the surface of the electrode and, consequently, having very good adhesion to the surface of the electrode.

Advantageously, the electro-grafting leads to a continuous polymeric film of uniform thickness, covering all of the electrically conductive or semi-conductive surface of the electrode, and does so irrespective of the surface topography of the electrode used.

Preparation of the Electrode/Gelled Electrolytic Membrane Assembly

As indicated previously, the electrically insulating electro-grafted polymeric film, prepared on the surface of an electrode, preferably of a lithium-based electrode, may advantageously be converted into a gelled electrolytic membrane.

More particularly, the gelled electrolytic membrane may be obtained by gelling the polymeric film by adding to said film a solution of lithium salt in a gelling agent, preferably of plastic crystal compound type.

Gelling Agent

Preferably, the gelling agent used for the purposes of forming a gel is more particularly a dinitrile compound of formula N≡C—R—C≡N, in which R is a CₙH₂ₙ hydrocarbon-based group, n being an integer between 1 and 6.

Such dinitrile compounds have already been described in WO 2017/032940 for forming a gel electrolyte in a lithium battery. However, their use in an electro-grafted polymer according to the invention has never been described.

The dinitrile compounds are preferably compounds belonging to the class of plastic crystal compounds.

The dinitrile compound advantageously has a melting point above 20° C., thus facilitating the handling of the electrolyte during the preparation of the battery according to the invention.

The dinitrile compound acts as solvent for the electrolytic medium of the gelled electrolytic membrane formed according to the invention.

Advantageously, the dinitrile compound is succinonitrile (n=2 in the abovementioned formula) or malononitrile (n=1 in the abovementioned formula).

According to a particular embodiment, the dinitrile compound is succinonitrile.

Succinonitrile is a flammable and nonvolatile hyper-plastic crystalline organic compound (boiling point: 266° C.) with a melting point of 57° C. Its potential working temperature range is between −20° C. and 250° C. By way of example, a 1M solution of LiTFSI salt in succinonitrile has an ion conductivity of the order of 3×10'S·cm⁻¹ at 20° C.

In general, the dinitrile compound makes it possible to dissolve the lithium salt of the electrolyte. In addition, its combination with the electro-grafted polymer makes it possible to obtain a gel.

It is understood that the dinitrile compound is used in a sufficient content to allow gelling of the electro-grafted polymer.

In particular, the dinitrile compound may be present in a dinitrile compound/polymer mass ratio of between 10/90 and 90/10, in particular between 25/75 and 75/25 and more particularly of the order of 50/50.

Other solvents for the gelling of said electro-grafted polymer may also be used, and in particular of carbonate type. They may be chosen, for example, from the cyclic or linear alkyl carbonates conventionally used for electrolyte preparation, taken alone or as a mixture, and chosen notably from dimethyl carbonate (DMC), diethyl carbonate (DEC), propylene carbonate (PC), vinylene carbonate (VC), vinylethylene carbonate (VEC), ethylene carbonate (EC), ethyl methyl carbonate (EMC), etc.

Preferably, the gelling solvent is a dinitrile compound as described previously.

Lithium Salt

The lithium salt used according to the invention may be chosen, in a conventional manner, from LiTFSI (lithium bis(trifluoromethanesulfonyl)imide), LiBOB (lithium bis(oxalato)borate), LiPF₆, LiClO₄, LiBF₄, LiAsF₆, LiCF₃SO₃, LiN(CF₃SO₂)₃, LiN(C₂F₅SO₂) (LiBETI), and mixtures thereof.

According to a particular embodiment, the lithium salt is LiTFSI.

In the gelled electrolyte, the concentration of lithium salt(s) in the dinitrile compound may be more particularly between 0.5 and 3 mol·L⁻¹, in particular of the order of 1 mol·L⁻¹.

Preferably, the [polymer]/[dinitrile compound+lithium salt] mass ratio is advantageously between 10/90 and 90/10, preferably between 25/75 and 75/25 and more particularly between 40/60 and 60/40.

This ratio makes it possible to achieve good properties, firstly in terms of ion conductivity afforded by the dinitrile compound+lithium salt mixture, in particular close to those afforded by a conventional liquid electrolyte, and secondly in terms of mechanical strength and insulation afforded by the electro-grafted polymer.

The gelled electrolytic membrane obtained according to the invention thus not only ensures its electrolytic function in a lithium battery, but also has good electrical insulating and mechanical strength properties.

In addition, the gelled electrolytic membrane has very good adhesion to the electrode, due to the polymer matrix electro-grafted to the surface of the electrode.

Advantageously, due to the optimized thickness of the film electro-grafted to the surface of the electrode, the gelled electrolytic membrane may have an optimum thickness, in particular a low thickness.

The thickness of the gelled electrolytic membrane may thus be less than or equal to 10 nm, in particular between 10 nm and 500 nm and more particularly between 50 nm and 200 nm.

Battery

The electrode/gelled electrolytic membrane assembly obtained according to the invention may be advantageously used in a lithium battery.

It may notably be used in a lithium-ion or lithium-metal battery, preferably a lithium-ion battery.

In particular, the electrode/electrolytic membrane assembly obtained according to the invention is assembled with the other conventional constituents of the battery (second electrode, current collectors).

Preferably, the electrode, which is preferably lithium-based, having at the surface the gelled electrolytic membrane, is used to form the positive electrode (or cathode) in a lithium battery.

Thus, a lithium battery according to the invention may comprise:
an assembly according to the invention formed from a lithium-based electrode supporting a gelled electrolytic membrane according to the invention; and
a negative electrode in contact with the face of the gelled electrolytic membrane that is opposite the positive electrode.

The negative electrode may be chosen from any electrode known in the field of lithium batteries. The active material of the negative electrode may be chosen, for example, from titanate of the type Li₄Ti₅Oi₂ (LTO), graphite carbon, sulfur, lithium metal, silicon. It may notably be an electrode based on lithium metal.

As for the positive electrode, the negative electrode active material may represent from 50% to 95%, in particular from 70% to 80%, relative to the mass of the electrode.

The electrodes may be combined in a conventional manner with a current collector. This may be a carbon nonwoven.

According to another of its aspects, the invention also relates to a process for preparing a lithium battery by assembling the electrode/gelled electrolytic membrane assembly obtained according to the invention with a negative electrode.

Advantageously, since the electrolyte is in the form of a gel, the battery according to the invention does not require a conventional separator. The gelled electrolytic membrane obtained according to the invention makes it possible to ensure both the movement of the lithium ions and the electrode-separating function.

Thus, the gelled electrolytic membrane of a battery according to the invention does not comprise any polymers other than the electro-grafted polymer derived from the electro-polymerization of the ionic liquid, as described previously.

The invention will now be described with the aid of the examples that follow, which are, needless to say, given as nonlimiting illustrations of the invention.

### EXAMPLE 1

Electrochemical Properties of the Gelled Polymer

The ion-conducting properties of an electrolyte of gelled polymer nature according to the invention were studied.

The polymer was synthesized conventionally via radical polymerization of the monomer N,N,N,N-n-butyldimethylmethacryloyloxyethylammonium bis(trifluoromethanesulfonyl)imide, abbreviated hereinbelow as BDMA. 10 g of monomer BDMA and 4 g of AIBN (azobisisobutyronitrile) were dissolved in 10 ml of THF (tetrahydrofuran) in a round-bottomed flask. The whole was heated at 60° C. under reflux for 24 hours. Next, the polymer was purified by precipitation from diethyl ether. It was then dried for 48 hours under vacuum at 80° C. and then stored in a glovebox under an inert atmosphere.

The polymer thus obtained, succinonitrile (SN), and LiTFSI (lithium bis(trifluoromethanesulfonyl)imide, content 1M relative to the mass of SN+BDMA) are then dissolved in THF. Various solutions are prepared with variable contents of polymer relative to the total weight of the polymer mixture relative to the succinonitrile: 0 wt %, 60 wt %, 70 wt %, 80 wt % and 100 wt %.

The various solutions prepared are summarized in table 1, the amounts being in grams.

TABLE 1

| Solutions tested⁽*⁾ | m (BDMA) | m (LiTFSI) | m (SN) |
|---|---|---|---|
| S1 (0 wt % BDMA) | 0 | 0.43 | 2 |
| S2 (60 wt % BDMA) | 0.5 | 0.19 | 0.38 |
| S3 (70 wt % BDMA) | 0.5 | 0.16 | 0.25 |
| S4 (80 wt % BDMA) | 0.5 | 0.14 | 0.13 |
| S5 (100 wt % BDMA) | 0.5 | 0.11 | 0 |

⁽*⁾given percentage of BDMA relative to the mass of BDMA + SN.

The solutions are then coated onto polyethylene films and dried in an oven at 50° C.

Evaluation of the Ion Conductivities

The various electrolytes are then mounted in a button cell, to take impedance measurements and to obtain their ion conductivities as a function of the temperature.

To do this, the electrolytes are placed in a polyethylene spacer, between two stainless-steel chocks. A spring is added to one of the lids to ensure optimum contact between the polymer and the chocks.

The impedance measurements are taken at frequencies of between 1 MHz and 10 MHz, at a sweep voltage of 10 mV.

The results in terms of ion conductivity as a function of the temperature are represented in FIG. 4.

The non-gelled polymeric electrolyte (S5) has Vogel-Tamman-Fulcher (VTF) behavior, i.e. nonlinear behavior. The change in conductivity with the temperature also depends on the mechanical changes that the polymer undergoes with the temperature, such as the glass transitions.

When the polymeric electrolyte is gelled (in the case of S1, S2, S3 and S4), the conductivity of the polymeric electrolyte gel follows an Arrhenius law with the temperature. Ion transport thus takes place in the liquid phase of the electrolyte, formed from the lithium salts in the dinitrile compound.

At and above 50 wt % of liquid phase (in the case of S3), ion conductivities close to that of liquid electrolytes are obtained at ambient temperature.

### EXAMPLE 2

Identification of the Electro-Grafting Potential

The electro-grafting of the polymer using the ionic liquid BDMA was tested on a glassy carbon electrode. This test shows the possibility of electro-grafting such a polymer and of determining the potential window in which the electro-grafting mechanism takes place.

To do this, an assembly (10) with three electrodes is used, as represented schematically in FIG. 2. The working electrode (1) is a glassy carbon electrode 3 mm in diameter. The counterelectrode (2) is a platinum wire. The reference electrode (3) is a solution containing 0.1 M of TEABF₄ (N,N,N-triethylethanaminium tetrafluoroborate) and 0.01M of AgNO₃ in acetonitrile, in which is immersed a silver wire.

These electrodes are placed in an electrolytic solution formed from 3 g of BDMA ionic liquid monomer and 0.1 g of LiTFSI.

This assembly is connected to a potentiostat (5) in order to perform cyclic voltammetries. A potential sweep between the OCV (“Open Circuit Voltage” or no-load current) and −3V vs Ag⁺/Ag⁰ is applied at a rate of 0.1 mV·s⁻¹.

The current intensity response is recorded, and represented in FIG. 5-a. The peak observed at −2 V vs Ag⁺/Ag⁰ corresponds to the electro-grafting. Next, after −2.5 V vs Ag⁺/Ag⁰ the solution electro-polymerization takes place.

A second electro-grafting experiment was performed at ambient temperature, taking a new electrolytic solution identical to the one used previously, and a clean glassy carbon electrode.

The potential was cut at −2.25 V vs Ag⁺/Ag⁰ with a sweep rate of 1 mV·s⁻¹.

The cyclic voltammetry curves obtained are represented in FIG. 5-b.

A decrease in the electro-grafting peak with the number of cycles performed is observed, which demonstrates insulation of the surface of the carbon electrode.

### EXAMPLE 3

Electro-Grafting on the Surface of a Lithium-Based Electrode

An assembly with three electrodes, similar to the one used in example 2, was used, except that the glassy carbon working electrode is replaced with a nickel electrode onto which is deposited a layer 15 μm thick of LiNiO₂ at the surface.

A potential sweep between the OCV and −2.25 V vs Ag⁺/Ag⁰ is applied at a sweep rate of 1 mV·s⁻¹.

The electro-grafting is performed at various temperatures (25° C., 40° C. and 60° C.). The curve “before Ep” corresponds to the curve obtained before electro-grafting.

The cyclic voltammetry curves obtained for the first sweep cycle, at the various temperatures, are represented in FIG. 6-a.

It is more difficult to identify the electro-grafting peak. However, it is clearly visible that the electro-grafting reaction (at a potential of −1.6 V vs)Ag⁺/Ag⁰ is greater at 60° C.

The cyclic voltammetry curves as a function of the cycles performed at a temperature of 60° C. are represented in FIG. 6-b.

This voltammogram shows a decrease in the current intensity during the cycles, thus showing that the working electrode is increasingly insulating.

### EXAMPLE 4

Insulation Tests

In addition to the voltammogram monitoring, an experiment was performed in order to demonstrate the insulation of the surface of the electrode on which the polymer according to the invention has been electro-grafted.

To do this, an assembly identical to the one used in example 3 is used, with three electrodes, the working electrode being the Ni/LiNiO₂ electrode, on which the electro-grafting was performed. The counterelectrode is made of platinum, and the reference electrode is a solution of AgNO₃ with a silver wire as described in example 3.

The electrolytic solution is a medium that is nonsolvent for the electro-grafted polymer (mixture of chloroform and methoxyperfluorobutane (1:1% V)) in which is dissolved a base salt (0.1 M of TEABF₄) and a RedOx probe (0.005M of 2,3-dichloro-5,6-dicyano-p-benzoquinone, abbreviated as DDB).

This RedOx probe is a molecule which reacts reversibly when a potential sweep is applied. Thus, in the case where the electrode is not insulated, the RedOx response of the molecule will be visible. On the contrary, if the electrode is insulated, the RedOx probe cannot react.

The insulation efficiency, by electro-grafting of the polymer according to the invention, performed at the various temperatures (25° C., 40° C. and 60° C.) is thus verified.

FIGS. 7-a, 7-b and 7-c represent the voltammograms obtained for the naked nickel/LiNiO₂ electrode in the electrolytic solution not containing the RedOx probe (“Blank without DDB”), for the naked nickel/LiNiO₂ electrode after addition of the probe (“Blank with DDB”) and for the nickel/LiNO₂ electrode functionalized by electro-grafting of the polymer, obtained on conclusion of 30 cycles, at different temperatures, as described in example 3, after addition of the RedOx probe (“DDB”).

It emerges from the voltammograms obtained that, for electro-grafting performed at 25° C., the response of the RedOx probe is virtually unchanged. The thickness of the electro-grafted polymer at the surface of the lithium-based electrode is insufficient to insulate the surface of the electrode.

For electro-grafting at 40° C., a marked decrease in the current intensity is observed. The thickness of the electro-grafted polymer is greater, but remains insufficient to totally insulate the surface.

For electro-grafting at 60° C., the RedOx probe no longer reacts. The lithium-based electrode is totally insulated.

### EXAMPLE 5

Study of the Sweep Rate on the Electro-Grafting

The same assembly as that described in example 3 is used. The electro-grafting is performed at 60° C. with sweep rates ranging from 1 to 100 mV/s.

The cyclic voltammetry curves obtained are represented in FIG. 8.

The faster the sweep rate, the higher the current intensities. However, for sweep rates of 10 and 100 mV·s⁻¹, the electro-grafting peaks are observed.

The same electrode insulation tests as those performed in example 4 with a RedOx probe were performed. The voltammograms obtained are represented in FIGS. 9-a, 9-b and 9-c for electro-graftings performed at 100, 10 and 1 mV/s.

The same type of observation may be made. For electro-grafting performed at a rate of 1 mV/s, the electrode is well insulated. The higher the sweep rate for the electro-grafting, the thinner the film formed, and the less the electrode is insulated.

### EXAMPLE 6

Synthesis on a Porous Structure

A test of electro-grafting of the polymer is performed on a 3D electrode.

An assembly with three electrodes, similar to the one described in example 3, was used, except that the working electrode is replaced with a nickel foam onto the surface of which is deposited a film 15 μm thick of LiNiO₂.

The electro-grafting is performed at 1 mV·s⁻¹ at 40° C.

The voltammogram obtained is represented in FIG. 10.

The electro-grafting peak at −1.5 V vs Ag⁺/Ag⁰ is clearly observed.

Furthermore, the current intensity decreases as the cycles increase, which indicates insulation of the surface.

This test clearly shows the possibility of performing the electro-grafting according to the invention on a porous surface.

1. A process for functionalizing the electrically conductive or semi-conductive surface of an electrode by electro-grafting of a polymeric film obtained from an ionic liquid monomer, the cation of which bears at least one electro-polymerizable function.

2. The process as claimed in claim 1, in which said electrode is intended for a lithium battery.

3. The process as claimed in claim 1, in which said electrode is a lithium-based electrode.

4. The process as claimed in claim 3, in which said electrode has at the surface a film of lithium transition metal oxide.

5. The process as claimed in claim 4, in which said electrode has at the surface a film of lithium nickel oxide (LiNiO₂).

6. The process as claimed in claim 1, in which the electro-grafting is performed using an electrolytic solution formed from said ionic liquid, where appropriate supplemented with a support electrolyte.

7. The process as claimed in claim 6, in which the electro-grafting is performed using an electrolytic solution formed from said ionic liquid supplemented with a lithium salt.

8. The process as claimed in claim 1, in which the electro-polymerizable function is an activated vinyl function.

9. The process as claimed in claim 1, in which the cation of said ionic liquid is an aliphatic ammonium cation corresponding to the general formula (II): 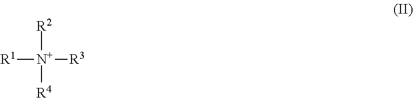
in which R1, R2, R3 and R4 represent, independently of each other, a hydrocarbon-based group, with at least one of the groups R1, R2, R3 and R4 being a hydrocarbon-based group bearing at least one electro-polymerizable function.

10. The process as claimed in claim 1, in which the cation of said ionic liquid is of formula (V) below: 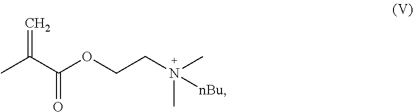
with nBu corresponding to n-butyl.

11. The process as claimed in claim 1, in which the anion of said ionic liquid is a compound comprising a heteroatom bearing a negative charge, this heteroatom being chosen from a nitrogen atom, a boron atom, a phosphorus atom or a chlorine atom.

12. The process as claimed in claim 1, in which the anion of said ionic liquid is an imide compound.

13. The process as claimed in claim 1, in which the bis(trifluoromethylsulfonyl)imide compound is of formula (XI) below:

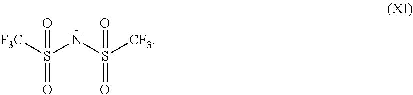 [SMILES: O=S(=O)(NS(=O)(=O)C(F)(F)F)C(F)(F)F]

14. The process as claimed in claim 1, in which the ionic liquid is N,N,N,N-n-butyldimethylmethacryloyloxyethylammonium bis(trifluoromethanesulfonyl)imide.

15. The process as claimed in claim 1, in which the electro-grafting is performed by polarization under cyclic voltammetry conditions, by adjusting the operating conditions to control the properties of the polymeric film formed.

16. The process as claimed in claim 1, comprising at least the steps consisting in:
(i) preparing an electrolytic solution comprising an ionic liquid, where appropriate supplemented with a support electrolyte;
(ii) electrolyzing said solution in an electrolysis cell using said electrode on which the polymeric film is to be formed, as working electrode, and at least one counterelectrode, under conditions suitable for the formation of a polymeric film covalently grafted onto the surface of the electrode.

17. A structure comprising an electrode having an electrically conductive or semi-conductive surface, onto which is covalently grafted a polymeric film, obtained by electro-polymerization from an ionic liquid monomer, the cation of which bears at least one electro-polymerizable function.

18. The structure as claimed in claim 17, wherein said electrode is a lithium-based electrode.

19. The structure as claimed in claim 17, wherein said electrode has at the surface a film of lithium transition metal oxide.

20. The structure as claimed in claim 17, wherein the electro-grafted polymeric film has a thickness of greater than or equal to 10 nm.

21. A structure comprising an electrode having an electrically conductive or semi-conductive surface, onto which is covalently grafted a polymeric film, obtained by electro-polymerization from an ionic liquid monomer, the cation of which bears at least one electro-polymerizable function, said polymeric film being obtained according to the electro-grafting conditions defined in claim 6.

22. A process for preparing a gelled electrolytic membrane on the surface of an electrode, preferably of a lithium-based electrode, comprising at least the following steps:
(a) providing an electrode, preferably a lithium-based electrode, on which is covalently grafted an electrically insulating polymeric film, obtained by electro-polymerization from an ionic liquid monomer, the cation of which bears at least one electro-polymerizable function;
(b) gelling the polymeric film by adding a solution of lithium salt in a dinitrile compound of formula N≡C—R—C≡N, in which R is a CnH2n hydrocarbon-based group, n being an integer between 1 and 6, or in one or more solvents such as carbonates.

23. A process for preparing a gelled electrolytic membrane on the surface of an electrode, preferably of a lithium-based electrode, comprising at least the following steps:
(a) providing an electrode, preferably a lithium-based electrode on which is covalently rafted an electrically insulating polymeric film, obtained by electro-polymerization from an ionic liquid monomer, the cation of which bears at least one electro: polymerizable function;
(b) gelling the polymeric film by adding a solution of lithium salt in a dinitrile compound of formula N≡C·R—C≡N, in which R is a CnH2n hydrocarbon-based group, n being an integer between 1 and 6, or in one or more solvents such as carbonates,
in which the electrode in step (a) provided at the surface with said electro-grafted polymeric film is obtained according to the electro-grafting conditions defined in claim 6.

24. The process as claimed in claim 22, in which the dinitrile compound is succinonitrile or malononitrile.

25. The process as claimed in claim 22, in which the [polymer]/[dinitrile compound+lithium salt] mass ratio is between 10/90 and 90/10.

26. An electrode/electrolytic membrane assembly, comprising an electrode supporting a gelled electrolytic membrane obtained on conclusion of the process as defined in claim 22.

27. The electrode/electrolytic membrane assembly as claimed in claim 26, in which the electrode is a lithium-based electrode.

28. The use of an electrode/electrolytic membrane assembly as defined in claim 27, in a lithium battery.

29. A lithium battery, comprising an electrode/electrolytic membrane assembly as defined in claim 27.

30. The A lithium battery, comprising:
an electrode/electrolytic membrane assembly as defined in claim 27, in which the electrode is a lithium-based electrode; and
a negative electrode in contact with the face of the gelled electrolytic membrane that is opposite the positive electrode.
